(19) United States
(12) Patent Application Publication
(10) Pub. No.: US 2014/0292748 A1
(43) Pub. Date: Oct. 2, 2014

(54) SYSTEM AND METHOD FOR PROVIDING STEREOSCOPIC IMAGE BY ADJUSTING DEPTH VALUE

(71) Applicant: Electronics and Telecommunications Research Institute, Daejeon (KR)

(72) Inventors: Yun Ji BAN, Daejeon (KR); Hae Dong KIM, Daejeon (KR); Hye Sun KIM, Daejeon (KR); Jung Jae YU, Seongnam (KR); Kyung Ho JANG, Daegu (KR); Myung Ha KIM, Daejeon (KR); Joo Hee BYON, Daejeon (KR); Seung Woo NAM, Daejeon (KR)

(73) Assignee: Electronics and Telecommunications Research Institute, Daejeon (KR)

(21) Appl. No.: 14/230,834

(22) Filed: Mar. 31, 2014

(30) Foreign Application Priority Data
Apr. 1, 2013 (KR) 10-2013-0035308

(51) Int. Cl. G06T 19/20; G06T 7/00

(52) U.S. Cl. CPC G06T 19/20; G06T 7/0075
USPC 345/419

(57) ABSTRACT

Provided is a system and method for providing a stereoscopic image by adjusting a depth value, the system including a depth value estimator to estimate a depth value of an object included in a first stereoscopic image from the stereoscopic image, a depth value adjusting unit to adjust the depth value in consideration of a display device, a stereoscopic image processing unit to process the first stereoscopic image to be a second stereoscopic image based on the adjusted depth value, and a stereoscopic image provider to provide the second stereoscopic image to the display device.

### CROSS-REFERENCE TO RELATED APPLICATION

This application claims the priority benefit of Korean Patent Application No. 10-2013-0035308, filed on Apr. 1, 2013, in the Korean Intellectual Property Office, the disclosure of which is incorporated herein by reference.

### BACKGROUND

1. Field

The present invention relates to technology for estimating a depth value of an object from a first stereoscopic image, and providing a second stereoscopic image in which the depth value is adjusted based on a display device.

2. Description of Related Art

In terms of producing a stereoscopic image, a depth value of the stereoscopic image may vary based on a size of a display device or a viewing distance from the display device. A director or a producer may set the depth value in consideration of the display device such that the stereoscopic image may provide a designed cubic effect using a predetermined display device.

Accordingly, there is a desire for a technology that may realize the designed cubic effect in the stereoscopic image produced by the director or the producer, without restrictions on a type of a display device.

### SUMMARY

An aspect of the present invention provides a system and method for providing a stereoscopic image realizing a designed cubic effect without restrictions on a type of a display device.

Another aspect of the present invention also provides a system and method for generating a depth map from a left image and a right image of a stereoscopic image and adjusting a depth image based on a size and a viewing distance of a display device.

According to an aspect of the present invention, there is provided a system for providing a stereoscopic image including a depth value estimator to estimate a depth value of an object included in a first stereoscopic image from the stereoscopic image, a depth value adjusting unit to adjust the depth value in consideration of a display device, a stereoscopic image processing unit to process the first stereoscopic image to be a second stereoscopic image based on the adjusted depth value, and a stereoscopic image provider to provide the second stereoscopic image to the display device.

According to another aspect of the present invention, there is also provided a method of providing a stereoscopic image including estimating a depth value of an object included in a first stereoscopic image from the stereoscopic image, adjusting the depth value in consideration of a display device, processing the first stereoscopic image to be a second stereoscopic image based on the adjusted depth value, and providing the second stereoscopic image to the display device.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a configuration of a system for providing a stereoscopic image according to an embodiment of the present invention;

FIG. 2 is a diagram illustrating depth value estimation according to an embodiment of the present invention;

FIGS. 3A through 3C are diagrams illustrating depth value adjustment according to an embodiment of the present invention;

FIGS. 4A through 4C are diagrams illustrating stereoscopic image processing according to an embodiment of the present invention; and

FIG. 5 is a flowchart illustrating a method of providing a stereoscopic image according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

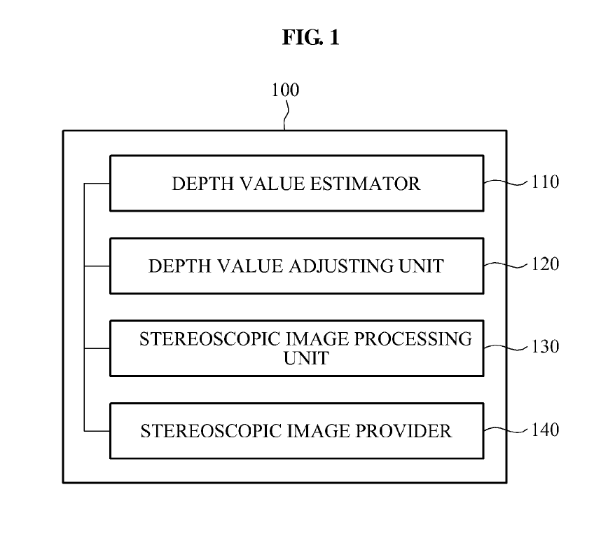

FIG. 1 is a block diagram illustrating a configuration of a system 100 for providing a stereoscopic image according to an embodiment of the present invention.

Referring to FIG. 1, the system 100 for providing a stereoscopic image includes a depth value estimator 110, a depth value adjusting unit 120, a stereoscopic image processing unit 130, and a stereoscopic image provider 140.

The depth value estimator 110 may estimate a depth value of an object included in a first stereoscopic image from the first stereoscopic image. The first stereoscopic image may be captured using two cameras, and be separated into a left image captured at a left side of the object and a right image captured at a right side of the object. The depth value estimator 110 may estimate the depth value by recognizing a matching object between the left image and the right image.

The depth value estimator 110 may estimate a zero depth value of a reference object included in a zero screen among objects. Here, the zero screen may be a point at which focuses of the two cameras match each other in the first stereoscopic image. Since the focuses of the two cameras match each other, the first stereoscopic image and the reference object may be seen at the same distance.

The depth value estimator 110 may estimate a negative depth value of an object visible over a short distance relative to the reference object. Here, the negative depth value is less than the zero depth value. For example, when an object included in the left image of the first stereoscopic image corresponds to the object visible over a short distance, the object included in the left image of the first stereoscopic image may be seen at a position horizontally different from a position of an object included in the right image which is paired with the left image in the first stereoscopic image. Also, the object included in the left image of the first stereoscopic image corresponding to the object visible over a short distance, when compared to a right side, may be positioned unevenly to a right side in the left image. When the left image and the right image come into sight of a left eye and a right eye, an image of the object may be focused at a shorter distance as compared to the first stereoscopic image. Thus, the depth value estimator 110 may set a relatively low depth value for the object.

The depth value estimator 110 may estimate a positive depth value of an object visible over a long distance relative to the reference object. For example, the object visible over a long distance relative to the reference object, when compared to the right image, may be positioned unevenly to the left side in the left image. Also, an image of the object visible over a long distance relative to the reference object may be focused at a longer distance as compared to the first stereoscopic image. Thus, the depth value estimator 110 may set a relatively high depth value for the object.

The depth value adjusting unit 120 may adjust the depth value in consideration of a size of a display device. When the size of display device is relatively small, the depth value may decrease as the first stereoscopic image is downscaled. When the size of display device is relatively large, the depth value may increase as the first stereoscopic image is upscaled.

The depth value adjusting unit 120 may adjust the depth image in consideration of a viewing distance from the display device. When the viewing distance from the display device is relatively short, the depth value of the first stereoscopic image may increase. When the viewing distance of the display device is relatively long, the depth value of the first stereoscopic image may decrease.

The depth value adjusting unit 120 may adjust, to be the estimated depth value, the depth value adjusted based on the size of display device and the viewing distance from the display device.

The depth value adjusting unit 120 may maintain a depth value of the reference object included in the zero screen among the objects included in the first stereoscopic image rather than adjusting the depth value of the reference object.

The stereoscopic image processing unit 130 may process the first stereoscopic image to be a second stereoscopic image using the adjusted depth value, through a depth image-based rendering (DIBR).

The DIBR may refer to a technology for producing a stereoscopic image from a piece of two-dimensional (2D) image or a plurality of 2D images, using a depth map. When the depth value is adjusted by the depth value adjusting unit 120, the stereoscopic image processing unit 130 may generate the depth map in which the depth value is set for each pixel included in the first stereoscopic image. The stereoscopic image processing unit 130 may calculate a disparity of the object using the depth map, thereby processing the second stereoscopic image.

The stereoscopic image provider 140 may provide the second stereoscopic image to the display device. Here, the display device may include a screen in a theater, a television, a projector, a laptop computer, and a smart phone.

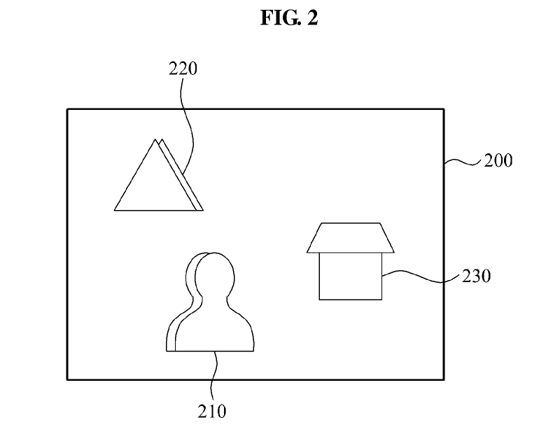

FIG. 2 is a diagram illustrating depth value estimation according to an embodiment of the present invention.

Referring to FIG. 2, a system for providing a stereoscopic image may estimate each depth value of an object 210, an object 220, and a reference object 230 included in a first stereoscopic image 200. The first stereoscopic image 200 may be produced by generating a composite of a left image and a right image, respectively captured at different sides of each of the object 210, the object 220, and the reference object 230 using two cameras. The left image and the right image included in the first stereoscopic image 200 may be recognized through a left eye and a right eye of a human body. The first stereoscopic image 200 may provide a cubic effect varying based on the depth value.

The system for providing a stereoscopic image may estimate a zero depth value of the reference object 230 included in a zero screen. The zero screen may refer to a portion of which a pixel value is not changed in a process of compositing the left image and the right image included in the first stereoscopic image 200. Since the reference object 230 displayed on the same position of the left image and the right image, the reference object 230 may be viewed at the same perspective distance as the first stereoscopic image 200.

The system for providing a stereoscopic image may estimate a negative depth value of the object 210 visible over a short distance relative to the reference object 230. The object 210 may be positioned unevenly to a right side in the left image when compared to the right image. When the left image and the right image are recognized through the left eye and the right eye, an image of the object 210 may be obtained at a shorter distance as compared to the first stereoscopic image 200. The system for providing a stereoscopic image may set a depth value less than the depth value of the reference object 230 for the object 210.

The system for providing a stereoscopic image may estimate a positive depth value of the object 220 visible over a long distance, relative to the reference object 230. The object 220 may be positioned unevenly to a left side in the left image when compared to the right image. When the left image and the right image are recognized through the left eye and the right eye, an image of the object 220 may be obtained at a longer distance as compared to the first stereoscopic image 200. The system for providing a stereoscopic image may set a depth value greater than the depth value of the reference object 230 for the object 220.

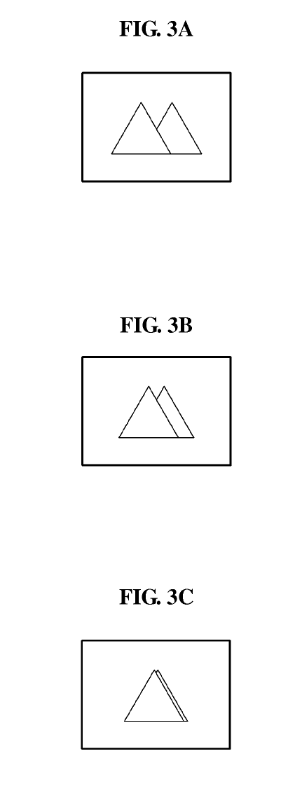

FIGS. 3A through 3C are diagrams illustrating depth value adjustment according to an embodiment of the present invention.

Referring to FIG. 3B, a system for providing a stereoscopic image may estimate a depth value of an object included in a first stereoscopic image, and adjust the depth image in consideration of a display device.

For example, when the first stereoscopic image of FIG. 3B is projected onto a display device having a size of 13 inches and a viewing distance of 10 meters (m), the first stereoscopic image may be displayed as shown in FIG. 3A

The system for providing a stereoscopic image may adjust the depth image in consideration of a size of a display device. When the size of the display device is relatively large, the depth value may increase as the first stereoscopic image is upscaled.

The system for providing a stereoscopic image may adjust the depth image in consideration of a viewing distance from the display device. When the viewing distance of the display device is relatively short, the depth value of the first stereoscopic image may increase. When the viewing distance of the display device is relatively long, the depth value of the first stereoscopic image may decrease. The system for providing a stereoscopic image may adjust, to be the estimated depth value, the depth value adjusted based on the size of display device and the viewing distance from the display device.

As another example, when the first stereoscopic image of FIG. 3B is projected on a display device having a size of five inches and a viewing distance of 1 m, the first stereoscopic image may be displayed as shown in FIG. 3C.

When the size of display device is relatively small, the depth value may decrease as the first stereoscopic image is downscaled. When the viewing distance from the display device is relatively long, the depth value of the first stereoscopic image may decrease. The system for providing a stereoscopic image may adjust, to be the estimated depth value, the depth value adjusted based on the size of display device and the viewing distance from the display device.

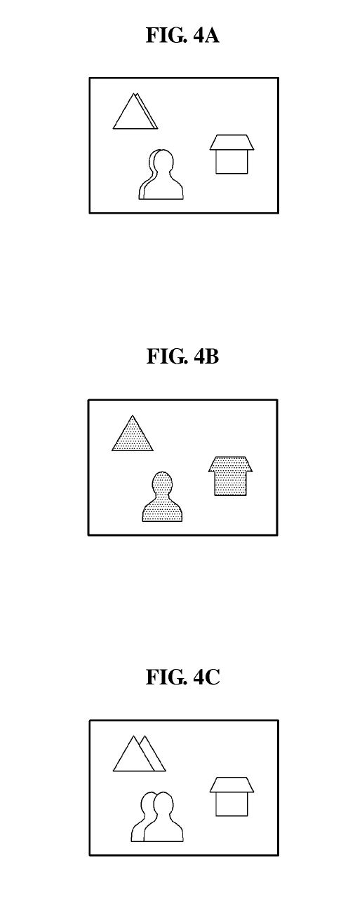

FIGS. 4A through 4C are diagrams illustrating examples of stereoscopic image processing according to an embodiment of the present invention.

Referring to FIG. 4A, the system for providing a stereoscopic image may estimate depth images of objects in a first stereoscopic image. The first stereoscopic image may include a reference object included in a zero screen, an object visible over a short distance relative to the reference object, and an object visible over a long distance relative to the reference object.

Referring to FIG. 4B, the system for providing a stereoscopic image may generate a depth map by setting a different depth value for each of the objects.

The system for providing a stereoscopic image may estimate a negative depth value of the object visible over a short distance relative to the reference object included in the zero screen, and estimate a positive depth value of the object visible over a long distance relative to the reference object. The depth map of FIG. 4B may include the same number of pixels as a number of pixels included in the first stereoscopic image of FIG. 4A, and allocate a value corresponding to the depth value for each of the pixels. For example, in the depth map of FIG. 4B, the system for providing a stereoscopic image may allocate a value between “0” to “255” for each of the pixels to express the depth values of the objects.

When a zero depth value is set for the reference object in the first stereoscopic image of FIG. 4A, the system for providing a stereoscopic image may allocate “128” to a pixel corresponding to the reference object.

When the negative depth value of the object visible over a short distance is estimated in the first stereoscopic image, the system for providing a stereoscopic image may allocate a value between “0” and “127” to a pixel corresponding to the object. When the positive depth value of the object visible over a long distance estimated in the first stereoscopic image, the system for providing a stereoscopic image may allocate a value between “129” and “255” to a pixel corresponding to the object. The depth map of FIG. 4B may be expressed in a lower brightness as the value allocated to the pixel, that is, the depth value of the object is increased.

The system for providing a stereoscopic image may adjust the depth in consideration of a display device. In the first stereoscopic image, the depth value may increase as the size of display device increases or the viewing distance from the display device decreases. In contrast, the depth value may decrease as the size of display device decreases or the viewing distance from the display device increases. The system for providing a stereoscopic image may adjust, to be the estimated depth value, the depth value adjusted based on the size of display device and the viewing distance from the display device.

The system for providing a stereoscopic image may process the first stereoscopic image of FIG. 4A to be a second stereoscopic image of FIG. 4C using the depth value adjusted in the depth map of FIG. 4B.

Referring to FIG. 4C, the system for providing a stereoscopic image may process the second stereoscopic image through a DIBR. In this instance, through the DIBR, the second stereoscopic image having a different viewpoint using the depth map of FIG. 4B and a piece of 2D image or a plurality of 2D images.

The system for providing a stereoscopic image may calculate a disparity of the object using the depth map of FIG. 4B. The disparity may refer to a difference of a pixel included in the first stereoscopic image of FIG. 4A visible through a left eye and a right eye of a human. To calculate the disparity, the system for providing a stereoscopic image may subtract the value allocated to the pixel included in the depth map of FIG. 4B from “1”, and multiply a result of the subtracting by a predetermined maximum disparity value.

The system for providing a stereoscopic image may process the second stereoscopic image of FIG. 4C by relocating the objects included in the first stereoscopic image of FIG. 4A in a left or right direction by the calculated disparity.

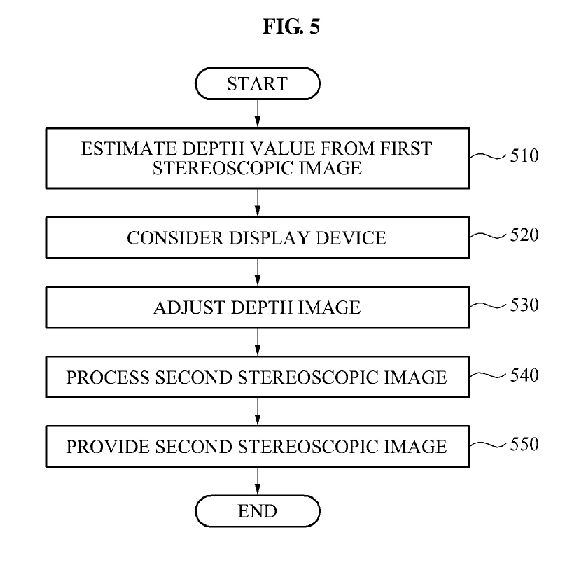

FIG. 5 is a flowchart illustrating a method of providing a stereoscopic image according to an embodiment of the present invention.

In operation 510, the system for providing a stereoscopic image may estimate a depth value of an object included in a first stereoscopic image from the first stereoscopic image. The first stereoscopic image may be captured using two cameras, and be separated into a left image captured at a left side of the object and a right image captured at a right side of the object. The system for providing a stereoscopic image may estimate the depth value by recognizing a matching object between the left image and the right image.

The system for providing a stereoscopic image may estimate a zero depth value of a reference object included in a zero screen among objects. Here, the zero screen may be a point at which focuses of the two cameras match in the first stereoscopic image. Since the focuses of the two cameras match, the first stereoscopic image and the reference object may be seen at the same distance.

The system for providing a stereoscopic image may estimate a negative depth value of an object visible over a short distance relative to the reference object. The object may be seen at a horizontally different position in a left image and a right image of the first stereoscopic image. The object may be positioned unevenly to the right side in the left image when compared to the right image. When the left image and the right image come into sight through a left eye and a right eye, an image of the object may be focused at a shorter distance as compared to the first stereoscopic image. Thus, the system for providing a stereoscopic image may set a relatively low depth value for the object.

The system for providing a stereoscopic image may estimate a positive depth value of an object visible over a long distance relative to the reference object. The object may be positioned unevenly to the left side in the left image when compared to the right image. In this case, an image of the object may be focused at a longer distance when compared to the first stereoscopic image. Thus, the system for providing a stereoscopic image may set a relatively high depth value for the object.

In operation 520, when the depth value is estimated, the system for providing a stereoscopic image may consider a display device. The system for providing a stereoscopic image may consider a size of a display device. When the size of the display device is relatively small, the depth value may decrease as the first stereoscopic image is downscaled. In contrast, when the size of the display device is relatively large, the depth value may increase as the first stereoscopic image is upscaled. Also, the system for providing a stereoscopic image may consider a viewing distance from the display device. When the viewing distance is relatively short, the depth value of the first stereoscopic image may increase. In contrast, when the viewing distance is relatively long, the depth value of the first stereoscopic image may decrease.

In operation 530, the system for providing a stereoscopic image may adjust the depth image based on the size of the display device and the viewing distance from the display device. In this instance, the system for providing a stereoscopic image may maintain a depth value of a reference object included in a zero screen among objects of the first stereoscopic image, rather than adjusting the depth value of the reference object.

In operation 540, when the depth value is adjusted, the system for providing a stereoscopic image may process the first stereoscopic image to be a second stereoscopic image through a DIBR. The DIBR may refer to a technology for producing a stereoscopic image from a piece of 2D image or a plurality of 2D images using a depth map. The system for providing a stereoscopic image may generate the depth map in which the adjusted depth value is set for each pixel included in the first stereoscopic image. The system for providing a stereoscopic image may calculate a disparity of the object to process the second stereoscopic image.

In operation 550, when the second stereoscopic image is processed, the system for providing a stereoscopic image may provide the processed stereoscopic image using the display device.

According to an embodiment of the present invention, it is possible to provide a system and method for providing a designed cubic effect without restrictions on a type of a display device.

According to another embodiment of the present invention, it is also possible to provide a system and method for automatically adjusting a depth image based on a size and a viewing distance of a display device.

The methods according to the above-described embodiments may be recorded, stored, or fixed in one or more non-transitory computer-readable media that includes program instructions to be implemented by a computer to cause a processor to execute or perform the program instructions. The media may also include, alone or in combination with the program instructions, data files, data structures, and the like. The program instructions recorded on the media may be those specially designed and constructed, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A system for providing a stereoscopic image, the system comprising:
a depth value estimator to estimate a depth value of an object included in a first stereoscopic image from the stereoscopic image;
a depth value adjusting unit to adjust the depth value in consideration of a display device;
a stereoscopic image processing unit to process the first stereoscopic image to be a second stereoscopic image based on the adjusted depth value; and
a stereoscopic image provider to provide the second stereoscopic image to the display device.

2. The system of claim 1, wherein the depth value estimator estimates, relative to a reference object included in a zero screen among objects, a negative depth value of an object visible over a short distance and a positive depth value of an object visible over a long distance.

3. The system of claim 2, wherein the depth value estimator estimates a zero depth value of the reference object.

4. The system of claim 1, wherein the depth value adjusting unit adjusts the depth value to decrease as a size of a screen of the display device increases, and adjusts the depth value to increase as the size of the screen of the display device decreases.

5. The system of claim 1, wherein the depth value adjusting unit adjusts the depth value to increase as a viewing distance increases, and adjusts the depth value to decrease as the viewing distance decreases.

6. The system of claim 4, wherein the depth value adjusting unit maintains a depth value of a reference object included in a zero screen among objects rather than adjusting the depth value of the reference object.

7. The system of claim 1, wherein the stereoscopic image processing unit processes the second stereoscopic image, through a depth image-based rendering (DIBR), to which the adjusted depth values are applied.

8. A method of providing a stereoscopic image, the method comprising:
estimating a depth value of an object included in a first stereoscopic image from the stereoscopic image;
adjusting the depth value in consideration of a display device;
processing the first stereoscopic image to be a second stereoscopic image based on the adjusted depth value; and
providing the second stereoscopic image to the display device.

9. The method of claim 8, wherein the estimating comprises estimating, relative to a reference object included in a zero screen among objects, a negative depth value of an object visible over a short distance and a positive depth value of an object visible over a long distance.

10. The method of claim 9, wherein the estimating comprises estimating a zero depth value of the reference object.

11. The method of claim 8, wherein the adjusting comprises adjusting the depth value to decrease as a size of screen of the display device increases, and adjusting the depth values to increase as the size of the screen of the display device decreases.

12. The method of claim 8 wherein the adjusting comprises adjusting the depth values to be increased as a viewing distance increases, and adjusting the depth values to be decreased as the viewing distance decreases.

13. The method of claim 11, wherein the adjusting comprises maintaining a depth value of a reference object included in a zero screen among objects rather than adjusting the depth value of the reference object.

14. The method of claim 8, wherein the processing comprises processing the second stereoscopic image, through a depth image-based rendering (DIBR), to which the adjusted depth values are applied.
